(19) United States
(12) Patent Application Publication
(10) Pub. No.: US 2025/0159548 A1
(43) Pub. Date: May 15, 2025

(54) DETERMINING DOWN-SAMPLING POINT IN SYMBOL SAMPLES

(71) Applicant: Microchip Technology Incorporated, Chandler, AZ (US)

(72) Inventors: Battu Prakash Reddy, Hyderabad (IN); Varaprasad Palivela, West Godavari (IN); Kranthi Kumar Ghanapuram, Jangaon (IN); Naga Srujit Adimulam, Anantapur (IN); Sunny Bazawada, Kakinada (IN)

(21) Appl. No.: 18/943,597

(22) Filed: Nov. 11, 2024

(30) Foreign Application Priority Data
Nov. 9, 2023 (IN) 202341076672

(51) Int. Cl. H04W 28/04

(52) U.S. Cl. CPC H04W 28/04

(57) ABSTRACT

A method may include obtaining samples associated with one or more symbols of a packet; determining at least one down-sampling point in a sequence of samples associated with a header portion of the packet; and utilizing samples associated with the determined down-sampling point to recover the one or more symbol and subsequent symbols.

### PRIORITY CLAIM

This application claims the benefit of the filing date of Indian patent application Ser. No. 20/234,1076672, filed Nov. 9, 2023, for “DETERMINING DOWN-SAMPLING POINT IN SYMBOL SAMPLES.”

### BACKGROUND

Electronic communication, including digital electronic communication, is used in a variety of operational context. Sometimes electronic communication involves symbol recovery.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting an apparatus to determine a down-sampling point, in accordance with one or more examples.

FIG. 2 is a block diagram depicting an apparatus for symbol recovery that offers down-sample point determination in accordance with one or more examples.

FIG. 3 is a block diagram depicting a for controlling down-sampling point determination, in accordance with one or more examples.

FIG. 4 is a block diagram depicting signal processing chain to recover symbols in a data stream that utilizes a down-sampling point determination, in accordance with one or more examples.

FIG. 5 is a signal diagram depicting examples of transmitted symbols.

FIG. 6 is a signal diagram depicting a portion of a down-sample window.

FIG. 7 is a block diagram of circuitry that, in some examples, may be used to implement various functions, operations, acts, processes, or methods disclosed herein.

FIG. 8 is a flow diagram depicting an example process 800 to determine a down-sampling point in symbol samples, in accordance with one or more examples.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

In digital electronic communication over a physical channel (e.g., wired, wireless, or combination thereof, without limitation), data may be converted to packets, further converted to bits, and further still converted to symbols that represent bits or groups of bits. The symbols represent specific physical states of a signal utilized to represent the bits or groups of bits. Symbols may correspond to respective voltage levels, respective phases of a carrier wave, respective frequencies, or combinations thereof. The process of mapping bits or groups of bits to physical states and the characteristics of these states depends on the modulation scheme used (e.g., QAM (Quadrature Amplitude Modulation), PSK (Phase Shift Keying), FSK (Frequency Shift Keying), without limitation). The symbols are transmitted over the physical channel after modulation.

Symbols may be filtered before transmission to, as non-limiting examples, reduce bandwidth requirement (bandwidth required to transmit), shape for available spectrum, reduce inter-symbol interference (ISI), or combinations thereof.

Additionally or alternatively to filtering, symbols may be up-sampled before transmission to, as a non-limiting example, increase the density of a data stream (e.g., create a denser and more detailed representation of a symbol's waveform, without limitation). When symbols are filtered and up-sampling, the up-sampling may be performed before, after, or during the filtering.

Up-sampling may involve, as a non-limiting example, increasing (e.g., via sampling rate, interpolation, or both, without limitation) the number of samples per symbol (the number of samples per symbol is referred to as the “sampling ratio”), increasing (e.g., via symbol replication, zero insertion, or both, optionally followed by low-pass filtering to reconstruct the higher-rate signal smoothly, without limitation) the number of instances of one or more symbols (the number of instances of symbols is also referred to as the “symbol rate”), or both. The increase in data density based on up-sampling is referred to as the “up-sampling ratio.”

At a receiver, the high-density data stream is down-sampled (e.g., before or after the symbols of the data stream pass through signal conditioning and phase/frequency compensation) and down-samples are utilized for symbol recovery. The inventors of this disclosure appreciate that down-samples suitable for symbol recovery typically occur at a consistent point within respective sets of up-samples for symbols. The process of determining a down-sampling point and indicating the same (e.g., so that down-samples may be chosen for symbol recovery, without limitation) may be referred to herein as “timing and synchronization.” An indication of a down-sampling point may be referred to herein as an “index.”

Approaches for determining the down-sampling point known to the inventions of this disclosure may utilize zero-crossing algorithms or Gardner algorithms, and loop filters to implement the same. Such algorithms typically use multiple samples (current, previous, and next samples) to identify a down-sampling point, which is complex, and stabilizing the loop filter may be challenging and costly. Further, such algorithms require continuous computation, which cause high power consumption and potential issues with drifting or hunting.

One or more examples relate, generally, to determining a down-sampling point for symbol recovery. In one or more examples, the determined down-sampling point may be in a set of up-samples of a symbol for a packet. In one or more examples, an index for the determined down-sampling point may be utilized to choose down-samples (e.g., choose up samples to be the down-samples, without limitation), which down-samples are utilized to recover symbols and optionally data.

In one or more examples, a process for determining a down-sampling point may include:

Obtain a down-sample window, which is a set (e.g., a sequence, without limitation) of samples (e.g., up-samples, without limitation). The obtained down-sample window may be a down-sample window of a set (e.g., a sequence, without limitation) of down-sample windows referred to herein as a “a max value window.” A subset or a totality of the down-sample windows of (e.g., within, without limitation) the max value window may obtained for analysis.

Perform a sequential maximum selection with index tracking on the sequence of samples of the down-sample window to determine a current max sample and a current max index. Here, “max” refers to the max value window of which the down-sample window is a member.

For the sequence of samples s₁, s₂, . . . , sₙ, initiate with a current max sample that is set to the value of the first sample s₁ and current max index set to 1. For each subsequent sample sᵢ at position i in the sequence, compare it to the current max sample. If sᵢ is greater than current max sample then update current max sample to the value of sᵢ and update current max index to i. If sᵢ is less than or equal to current max sample, do not update current max index or current max index. Loop until performed for all samples in the sequence. Upon performing for all samples in the sequence then the current max sample is the greatest sample and current max index is its position in the sequence. Its position within the sequence may be utilized as the down-sampling point. Obtain a next down-sample window, if available, and repeat, but for subsequent down-sample windows start with the current max sample and current max index determined processing the previous down-sample window.

The max value is the determined highest one of the samples across all down-sample windows of the max value window, and the max index is the index of the max value.

In one or more examples, samples (e.g., an up-sample, a down-sample, without limitation) are values (e.g., discrete values, without limitation) that represent symbols.

In one or more examples, the number of down-sample windows in a respective max value window is settable (capable of being set, e.g., programmable or configurable, without limitation). The number of down-sample windows may be set at least partially based on specific operating conditions, such as a predetermined number of binary transitions (1 to 0 and 0 to 1) and a confidence level of the presence of the predetermined number of binary transitions present in a max value window, without limitation. In one or more examples, the number of samples in a respective down-sample window is settable.

In one or more examples, a max value window may generally correspond to a header portion of a packet. Upon processing the header, the determination of the down-sampling point may stop and the determined max index may be utilized for symbol recovery for the rest of the packet. In one or more examples, a control signal may be generated to indicate whether determination of the down-sampling point should occur or not. When a next packet is obtained, the max value and corresponding index search may be performed on the header portion of the next packet and subsequent packets.

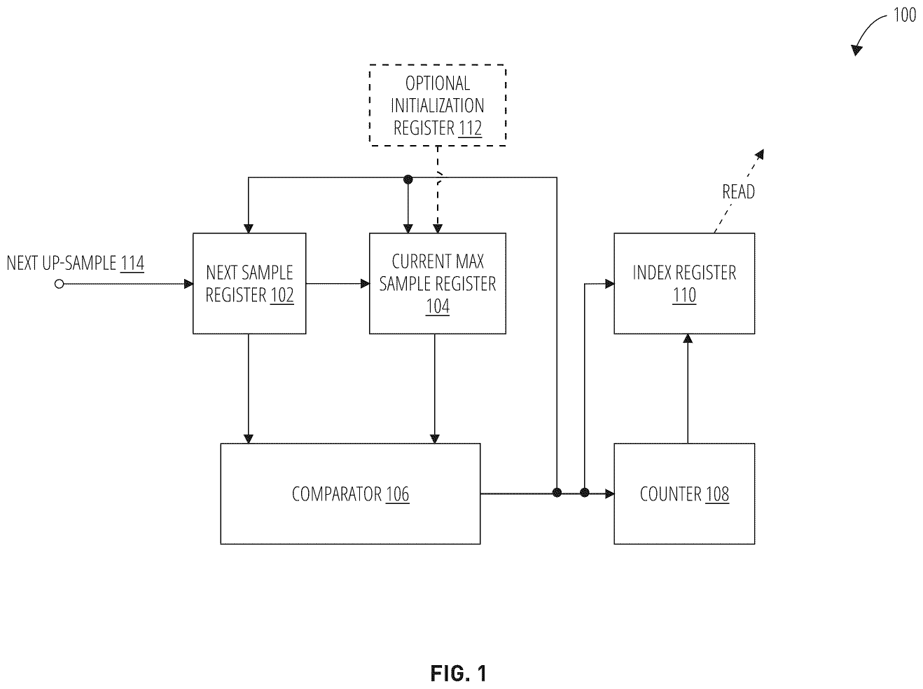

FIG. 1 is a block diagram depicting an apparatus 100 to determine a down-sampling point, in accordance with one or more examples.

Apparatus 100 includes a next sample register 102, a current max sample register 104, a comparator 106, a counter 108, an index register 110, and an optional initialization register 112.

Next sample register 102 receives and stores a next up-sample 114 (e.g., receives and stores a value that is the next up-sample 114, without limitation). The stored next up-sample 114 will be used for comparison as discussed below.

Current max sample register 104 receives and stores a value that is either the current max sample or the initialized value being used as the current max sample. The current max sample is the max sample found during a sequential maximum search discussed herein. Generally, the current max sample corresponds to the highest sample value found so far. In the case of the initialized value being used as the current max sample, it may come from an optional initialization register 112, discussed below. The current max sample register 104 is initially set to the initialized value and updates its value when the value of the incoming sample from the next sample register 102 is greater than the stored value.

Optional initialization register 112 provides an initialized value to the current max sample register 104. In one or more examples, the initialized value may be set to zero or another suitable starting value to ensure that the register starts with a defined state for comparison.

Comparator 106 compares the value of the sample stored at next sample register 102 with the value stored at current max sample register 104 and sets its output to indicate whether the value stored at current max sample register 104 is greater than the value stored at next sample register 102.

In one or more examples, if a new packet is processed after a previous packet has already been processed, the system starts with known, valid values obtained from the previous packet: e.g., use the final values-current max sample and current max index of the previous packet from the previous packet as the starting point of processing the next packet.

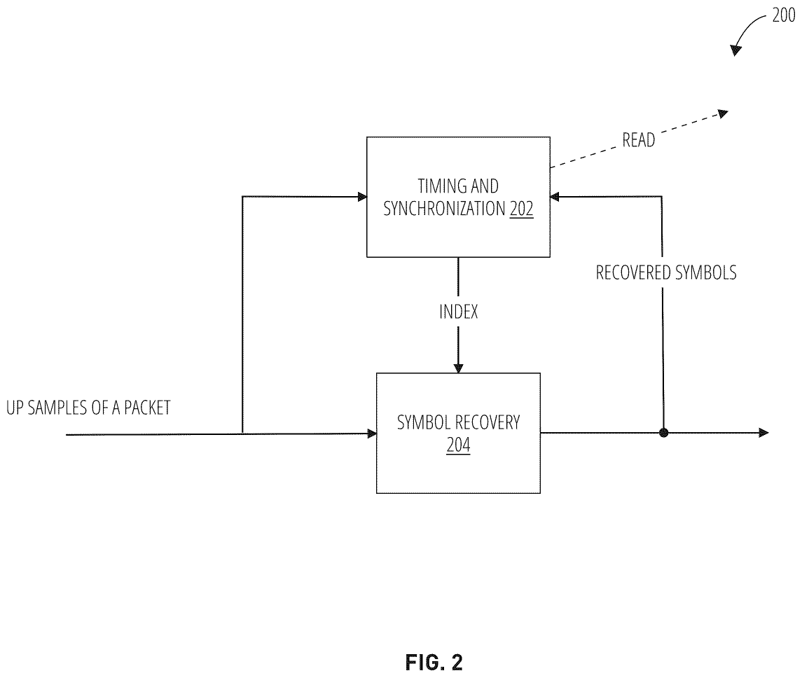

If no packet has already been processed or if for some reason use of the values from the previous packet is undesirable: obtain a random (random or pseudorandom) value and set the current max sample to the random value and set the current max index equal to 1. These initial values may be (and probably are) wrong but starting with potentially incorrect values is acceptable because the start of packet delimiter for a packer header is repeated, so the timing and synchronization block (e.g., timing and synchronization 202 of FIG. 2) and symbol recovery block (e.g., symbol recovery 204 of FIG. 2) may run for multiple iterations to refine the timing and synchronization, ensuring that symbol recovery can detect and align with the packet header despite initial inaccuracies.

If the output of comparator 106 is set to indicate that the value of current max sample register 104 is not greater than the value stored at next sample register 102, the value stored at next sample register 102 is received at current max sample register 104 (current max sample register 104 is updated with the value of next sample register 102). If the output of comparator 106 is set to indicate that the value of current max sample register 104 is greater than the value stored at next sample register 102, then current max sample register 104 is not updated with the value stored at next sample register 102 (current max sample register 104 continues to store the same value).

Counter 108 increments a count each cycle that tracks the position (index) of each incoming up-sample in the sequence. The value of the count indicates the sample stored at next sample register 102 that is being compared to the sample stored at current max sample register 104. Counter 108 resets each time the symbol count exceeds a predetermined threshold. In or more examples, such a predetermined threshold may be set based on a predetermined number of symbols in a down-sample window. In one or more examples, a reset signal may be an internal reset signal of counter 108 (e.g., counter 108 includes logic to store a predetermined threshold, observe when the count exceeds the predetermined threshold, and assert the reset signal, without limitation) or an external reset signal provided to counter 108 by a logic circuit (not depicted) that indicates boundaries of down-sample windows.

Index register 110 stores the current max index, which may be read (e.g., by a symbol recovery block). Index register 110 receives the index value from the counter 108 when the comparator determines that the next sample should update the current max sample. In one or more examples, the value of current max index may be updated based on the value of the count at counter 108 at least partially in response to response the output of comparator 106 being set to indicate that a value of current max sample register 104 is greater than a value stored at next sample register 102.

In one or more examples, action of apparatus 100 may be enabled/disabled at least partially in response to control signals. As a non-limiting example, a clock gate (not depicted) may provide a gated clock signal to next sample register 102, current max sample register 104, comparator 106, counter 108, and index register 110. In response to a control signal set to indicate that the down-sampling point determination should be performed the clock gate may provide a gated clock signal that corresponds to a clock signal (e.g., propagate the clock signal or a signal based thereon, without limitation). In response to a control signal set to indicate that the down-sampling point determination should not be performed the clock gate may hold the state of the gated clock signal (e.g., block the clock signal, without limitation). This effectively freezes the state of the downstream circuitry (e.g., apparatus 100, without limitation).

FIG. 2 is a block diagram depicting an apparatus 200 for symbol recovery that offers down-sample point determination in accordance with one or more examples. Timing and synchronization 202 may be or include, as a non-limiting example, an apparatus 100 of FIG. 1.

Timing and synchronization 202 determines the correct down-sampling point (determined index) within the sequence of up-samples for a packet. Timing and synchronization 202 receives up-samples from the packet and processes them to identify an index that points to the best sample for symbol recovery. The identified index is used to control which samples are selected as the down-sampled points for further processing. The index determined by timing and synchronization 202 (the determined index represents the down-sampling point) is provided to symbol recovery 204 for recovery of symbols.

Symbol recovery 204 receives the index from the timing and synchronization 202 and utilizes the index to select specific up-samples from the packet for conversion back into symbols. More specifically, symbol recovery 204 receives up-samples of the packet and receives the index from timing and synchronization 202, and selected samples (based on the received index) are processed to reconstruct and output recovered symbols of the packet.

The output (e.g., recovered symbols, without limitation) of the symbol recovery 204 is provided to timing and synchronization 202. The recovered symbols provided to timing and synchronization 202 may be utilized to observe packet headers and enable/disable down-sampling point determination as discussed above. A max value window may correspond to a header, a portion of a header, portions of a header and another portion of a packet, or another portion of a packet without exceeding the scope of this disclosure.

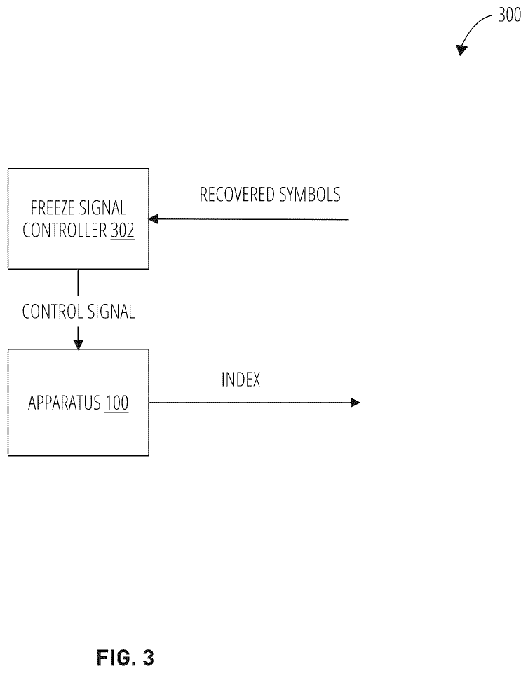

FIG. 3 is a block diagram depicting a 300 for controlling down-sampling point determination, in accordance with one or more examples.

Apparatus 300 includes freeze signal controller 302 and an apparatus 100. Apparatus 300 is a non-limiting example of an apparatus 200.

Freeze signal controller 302 provides a control signal that manages the process of freezing or halting updates to the current max sample and index. Freeze signal controller 302 sets a control signal at least partially based on recovered symbols provided by a symbol recovery block (e.g., symbol recovery 204 of FIG. 2, without limitation). In one or more examples, 302 may set the control signal to instruct apparatus 100 to perform, or not perform, a down-sampling point determination as discussed, above. In one or more examples, the control signal is triggered at least partially based on the status of the symbol recovery process. In one or more examples, freeze signal controller 302 monitors the status of the symbol recovery process at least partially based on recovered symbols output by apparatus 100.

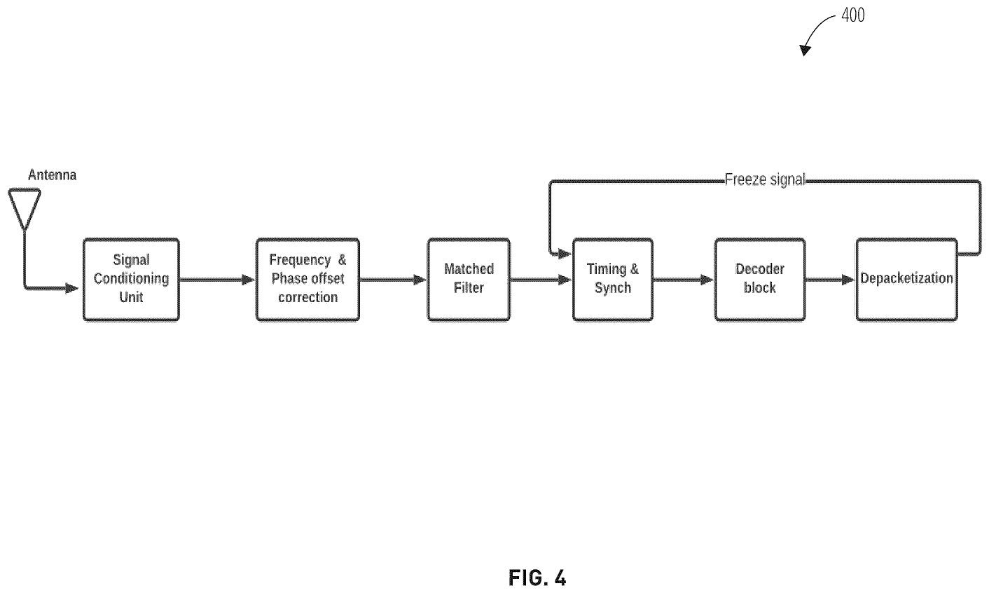

FIG. 4 is a block diagram depicting signal processing chain 400 to recover symbols in a data stream that utilizes a down-sampling point determination, in accordance with one or more examples. Signal processing chain 400 includes an antenna, signal conditioning unit, phase/frequency offset correction, matched filter, timing and synchronization, decoder, and depacketization. In one or more examples, timing and synchronization is implemented as discussed above with respect to one or more of FIG. 1, FIG. 2, or FIG. 3. More specifically, it determines the correct down-sampling points to align the signal's timing for symbol recovery as discussed above, and sends a freeze signal when the correct timing has been established, indicating the process of identifying new down-sampling points is temporarily halted. The decoder converts the sampled data (symbols) into a format suitable for further processing, e.g., by demodulating or decoding it based on the modulation scheme used. Decoder takes in the index and aligned samples from the timing and synchronization and decodes the aligned samples based on the index into baseband data for interpretation. Depacketization breaks decoded data into usable packets or data structures for further processing. Depacketization ensures that the data is structured correctly for the final application, whether for transmission to higher protocol layers or direct usage.

In one or more examples, the timing and synchronization for symbol recovery is implemented solely during the header period (e.g., while processing a header portion of the packet, without limitation). The at least one down-sampling point is in a sequence of samples associated with a header portion of the packet. The index utilized for symbol recovery is frozen while processing the portions of the packet outside of the max value window (e.g., the down-sampling point is determined solely during the header period of the packet, after which it remains fixed for the remainder of the packet, without limitation).

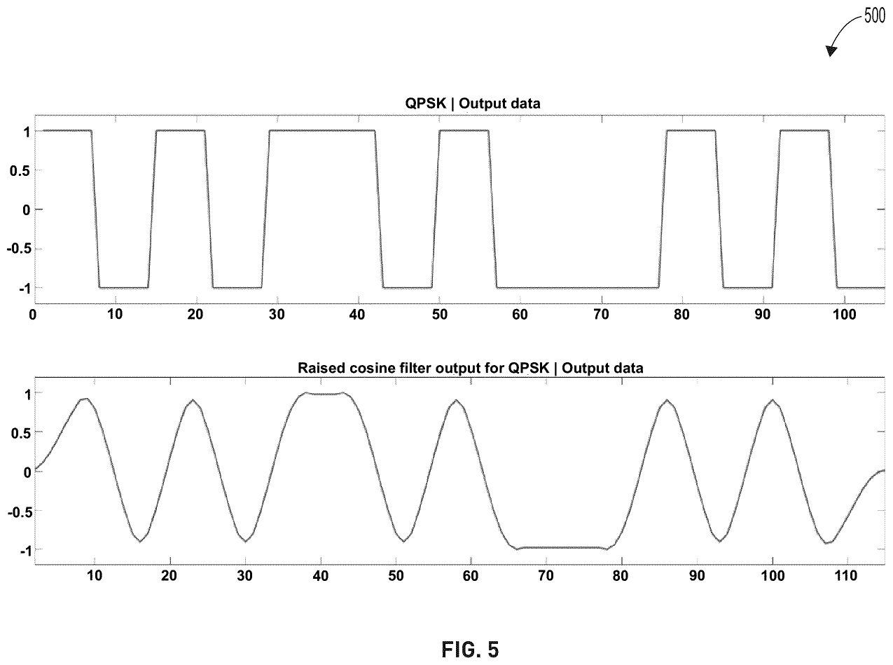

FIG. 5 is a signal diagram depicting examples of transmitted symbols. The Upper graph (QPSK Output Data) shows a typical digital output waveform representing the QPSK-modulated data. This waveform depicts the raw output data after modulation, with distinct amplitude levels corresponding to the encoded symbols. The lower graph (Raised Cosine Filter Output for QPSK Output Data) illustrates the output of the QPSK signal after it passes through a raised cosine filter. This filtering smooths the digital waveform to reduce high-frequency components and minimize Inter-Symbol Interference (ISI). The upper and lower graphs visually represent the difference between raw QPSK output data and the output after applying a raised cosine filter. FIG. 5 highlights the impact of filtering on signal integrity and the reduction of ISI. In the context of timing and synchronization, FIG. 5 illustrates how the signal looks before and after filtering. The Timing and synchronization block works with these filtered signals to identify the correct down-sampling points, ensuring accurate symbol recovery.

The filtered output shows rounded transitions between symbol levels, which aligns with the raised cosine filtering characteristics used to prepare the signal for transmission.

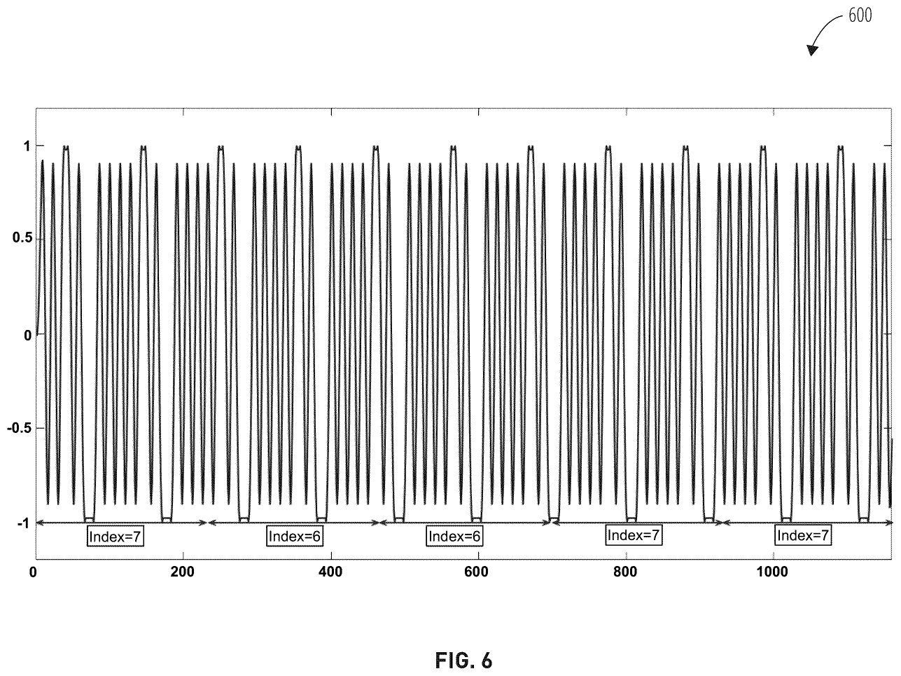

FIG. 6 is a signal diagram depicting a portion of a down-sample window. FIG. 6 shows a detailed waveform plot with labeled indexes indicating specific sampling points within the waveform. The plot shows a high-density data stream, likely representing an up-sampled signal used for symbol recovery. The waveform oscillates between positive and negative values, typical for digital communication signals. FIG. 6 includes labeled points along the waveform at specific intervals, marked as Index=7, Index=6, and so on and so forth. These labels indicate the selected down-sampling points identified by the timing and synchronization block during the processing. Each labeled index in FIG. 6 corresponds to the sample within the up-sampled sequence that is chosen as the optimal point for symbol extraction.

FIG. 6 visualizes how the timing and synchronization process identifies the best points for down-sampling across a sequence of up-samples. These points (e.g., Index=6, Index=7) are selected as the most suitable locations for symbol recovery, ensuring alignment with the signal's peak or most representative part.

Max value is searched in a user configurable window size. The max value is used to set the index, which is used for symbol recovery as discussed herein.

It will be appreciated by those of ordinary skill in the art that functional elements of examples disclosed herein (e.g., functions, operations, acts, processes, or methods) may be implemented in any suitable hardware, software, firmware, or combinations thereof.

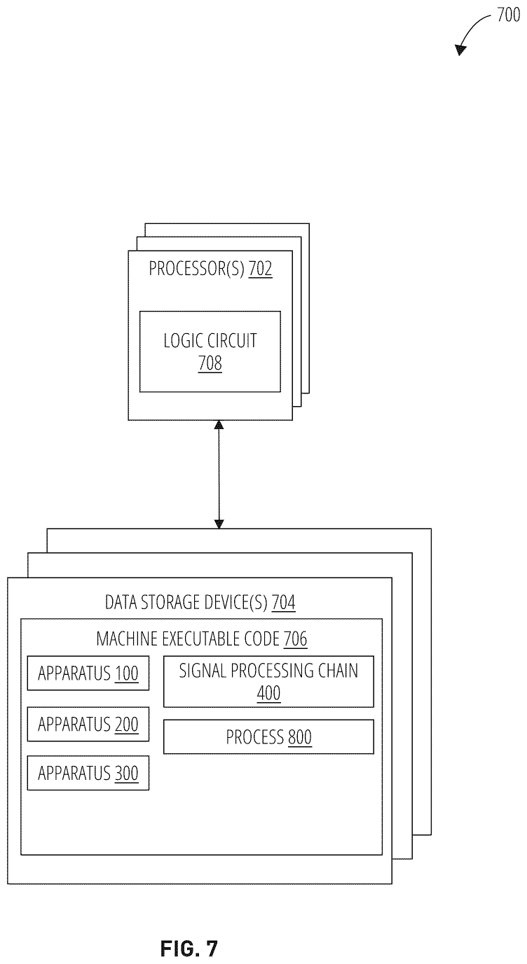

FIG. 7 illustrates non-limiting examples of implementations of functional elements disclosed herein. In some examples, some or all portions of the functional elements disclosed herein may be performed by hardware capable of carrying out the functional elements.

FIG. 7 is a block diagram of a circuitry 700 that, in some examples, may be used to implement various functions, operations, acts, processes, or methods disclosed herein. The circuitry 700 includes one or more processors 702 (sometimes referred to herein as “processors 702”) operably coupled to one or more data storage devices 704 (sometimes referred to herein as “storage 704”). The storage 704 includes machine executable code 706 stored thereon and the processors 702 include logic circuit 708. The machine executable code 706 includes information describing functional elements that may be implemented by (e.g., performed by) the logic circuit 708. The logic circuit 708 is adapted to implement (e.g., perform) the functional elements described by the machine executable code 706. The circuitry 700, when executing the functional elements described by the machine executable code 706, should be considered as special purpose hardware for carrying out functional elements disclosed herein. In one or more examples, the processors 702 may perform the functional elements described by the machine executable code 706 sequentially, concurrently (e.g., on one or more different hardware platforms), or in one or more parallel process streams.

When implemented by logic circuit 708 of the processors 702, the machine executable code 706 adapts the processors 702 to perform operations of examples disclosed herein. By way of non-limiting example, the machine executable code 706 may adapt the processors 702 to perform some or a totality of operations of processes discussed herein.

The processors 702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device (PLD), discrete gate or transistor logic, discrete hardware components, other programmable device, or any combination thereof designed to perform the functions disclosed herein. A general-purpose computer including one or more processors 702, including a general-purpose processor, is considered a special-purpose computer at least while the general-purpose computer executes functional elements corresponding to the machine executable code 706 (e.g., software code, firmware code, configuration data, hardware descriptions, without limitation) related to examples of the present disclosure. It is noted that a general-purpose processor (which may also be referred to herein as a host processor or simply a host) may be a microprocessor, but in the alternative, a general-purpose processor of processors 702 may include any conventional processor, controller, microcontroller, or state-machine. An FPGA or other PLD of the processors 702 may be configured (e.g., programmed, without limitation) with configuration data to perform functions disclosed herein, or, additionally or alternatively, may be capable of being configured or re-configured (e.g., programmable, or re-programmable, without limitation) with configuration data to perform functions disclosed herein. The processors 702 may also be implemented as a combination of computing devices, such as a combination of a DSP and a microprocessor, a plurality of microprocessors, one or more microprocessors in conjunction with a DSP core, or any other such configuration.

In one or more examples, the storage 704 includes volatile data storage (e.g., random-access memory (RAM), static RAM (SRAM), without limitation), non-volatile data storage (e.g., Flash memory, a hard disc drive, a solid-state drive, erasable programmable read-only memory (EPROM), without limitation). In some examples the processors 702 and the storage 704 may be implemented into a single device (e.g., a semiconductor device product, a system on chip (SOC), without limitation). In some examples the processors 702 and the storage 704 may be implemented into separate devices.

In one or more examples the machine executable code 706 may include computer-readable instructions (e.g., software code, firmware code). By way of non-limiting example, the computer-readable instructions may be stored by the storage 704, accessed directly by the processors 702, and executed by the processors 702 using at least the logic circuit 708. Also by way of non-limiting example, the computer-readable instructions may be stored on the storage 704, transferred to a memory device (not shown) for execution, and executed by the processors 702 using at least the logic circuit 708. Processors 702 or logic circuit 708 thereof be coupled to such a memory device or include such a memory device (e.g., a configuration memory cell, without limitation). Accordingly, in some examples the logic circuit 708 includes electrically configurable logic circuit 708.

In one or more examples the machine executable code 706 may describe hardware (e.g., circuitry) to be implemented in the logic circuit 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 708 may be described in a RTL and then converted by a Synthes tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine executable code 706 may include an HDL, an RTL, a GL description, a mask level description, other hardware description, or any combination thereof.

In examples where the machine executable code 706 includes a hardware description (at any level of abstraction), a system (not shown, but including the storage 704) implements the hardware description described by the machine executable code 706. By way of non-limiting example, the processors 702 may include a programmable logic device (e.g., an FPGA or a PLC, without limitation) and the logic circuit 708 may be electrically controlled (e.g., via configuration data, without limitation) to implement circuitry corresponding to the hardware description into the logic circuit 708. Also by way of non-limiting example, the logic circuit 708 may include hard-wired logic manufactured by a manufacturing system (not shown, but including the storage 704) according to the hardware description of the machine executable code 706.

Regardless of whether the machine executable code 706 includes computer-readable instructions or a hardware description, the logic circuit 708 is adapted to perform the functional elements described by the machine executable code 706 when implementing the functional elements of the machine executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

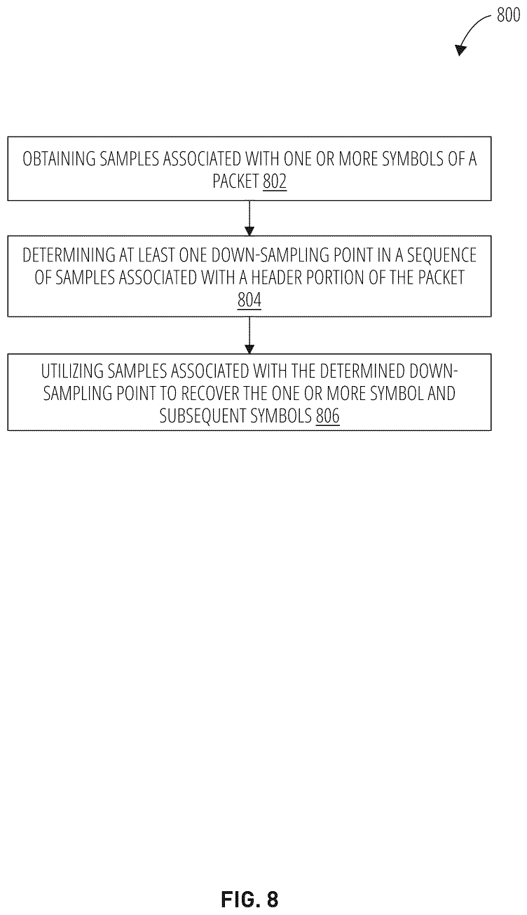

FIG. 8 is a flow diagram depicting an example process 800 to determine a down-sampling point in symbol samples, in accordance with one or more examples. Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

According to one or more examples, process 800 may include obtaining samples associated with one or more symbols of a packet at operation 802. In one or more examples, the obtained samples are up-samples. The up-samples are samples of a signal taken at a higher rate than the original symbol rate of the data (sampling rate>original symbol rate).

According to one or more examples, process 800 may include determining at least one down-sampling point in a sequence of samples associated with a header portion of the packet at block 804. In one or more examples, process 800 determines the down-sampling point exclusively during the header portion of the packet, and does not determine down-sampling point during portions of the packet other than the header portion. In one or more examples, the header portion may be defined as a fixed time window, corresponding to a predetermined time duration starting at the beginning of the packet or at a delimiter that indicates a start of a header. This predetermined time duration may be based on the bit rate or symbol rate and a number of bits or number of symbols in the header portion (header length). In one or more examples, the header portion may be defined based on a specific number of symbols or bits. In one or more examples, the header portion may be defined based on a known pattern of symbols or synchronization sequence. In one or more examples, the header portion may be dynamically determined, for example, the header portion may be defined based on a time when the system is actively processing and synchronizing with the header of a packet, without limitation.

In one or more examples, process 800 may freeze a determined down-sampling point for the reminder of the packet.

According to one or more examples, process 800 may include utilizing samples associated with the determined down-sampling point to recover the one or more symbol and subsequent symbols at block 806. As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended concepts (e.g., bodies of the appended concepts, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced concept recitation is intended, such an intent will be explicitly recited in the concept, and in the absence of such recitation no such intent is present. For example, as an aid to understanding, the following appended concepts may contain usage of the introductory phrases “at least one” and “one or more” to introduce concept recitations. However, the use of such phrases should not be construed to imply that the introduction of a concept recitation by the indefinite articles “a” or “an” limits any particular concept containing such introduced concept recitation to examples containing only one such recitation, even when the same concept includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce concept recitations.

In addition, even if a specific number of an introduced concept recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, concepts, or drawings, should be understood to contemplate the possibilities of including one of the terms, either of the terms, or both terms. For example, the phrase “A or B” should be understood to include the possibilities of “A” or “B” or “A and B.”

### Additional Non-Limiting Examples Include:

### Example 1

A method, comprising: obtaining samples associated with one or more symbols of a packet; determining at least one down-sampling point in a sequence of samples associated with a header portion of the packet; and utilizing samples associated with the determined down-sampling point to recover the one or more symbol and subsequent symbols.

### Example 2

The method according to Example 1, wherein the subsequent symbols are recovered without re-determining the down-sampling point or determining a new down-sampling point.

### Example 3

The method according to any of Examples 1 and 2, wherein the obtained samples are up-samples of the packet.

### Example 4

The method according to any of Examples 1 through 3, comprising freezing the determined down-sampling point after the header portion of the packet is processed, and maintaining the frozen down-sampling point for the duration of the packet.

### Example 5

The method according to any of Examples 1 through 4, comprising initializing a current max sample register with a predetermined or random value before determining the down-sampling point.

### Example 6

The method according to any of Examples 1 through 5, wherein determining the down-sampling point comprises sequentially comparing each sample in the header portion to identify the sample with the highest value.

### Example 7

The method according to any of Examples 1 through 6, further comprising resetting or reinitializing the down-sampling point determination process at the start of a new packet.

### Example 8

The method according to any of Examples 1 through 7, further comprising generating a control signal to freeze the down-sampling point after the header portion is processed.

### Example 9

The method according to any of Examples 1 through 8, wherein the determining at least one down-sampling point in the sequence of samples associated with the header portion of the packet comprises determining the at least one down-sampling point at least partially based on a sequential search for a highest sample within the header portion.

### Example 10

An apparatus, comprising: a symbol recovery circuit; and a timing and synchronization circuit to determine at least one down-sampling point at least partially based on a sequence of samples associated with a header portion of a packet and indicate the determined down-sampling point to the symbol recovery circuit.

### Example 11

The apparatus according to Example 10, wherein the symbol recovery circuit to recover subsequent symbols without re-determining or determining a new down-sampling point after the initial down-sampling point is determined.

### Example 12

The apparatus according to any of Examples 10 and 11, wherein the timing and synchronization circuit to obtain up-samples of the packet as the sequence of samples associated with the one or more symbols.

### Example 13

The apparatus according to any of Examples 10 through 12, wherein the timing and synchronization circuit to freeze the determined down-sampling point after the header portion of the packet is processed and maintain the frozen down-sampling point for the duration of the packet.

### Example 14

The apparatus according to any of Examples 1 through 13, further comprising a current max sample register to be initialized with a predetermined or random value before the timing and synchronization circuit determines the down-sampling point.

### Example 15

The apparatus according to any of Examples 1 through 14, wherein the timing and synchronization circuit to determine the down-sampling point by sequentially comparing each sample in the header portion to identify the sample with the highest value.

### Example 16

The apparatus according to any of Examples 1 through 15, wherein the timing and synchronization circuit to reset or reinitialize the down-sampling point determination process at the start of a new packet.

### Example 17

The apparatus according to any of Examples 1 through 16, further comprising a control signal generator to generate a control signal to freeze the down-sampling point after the header portion of the packet is processed.

### Example 18

The apparatus according to any of Examples 1 through 17, wherein the timing and synchronization circuit to determine the at least one down-sampling point in the sequence of samples associated with the header portion of the packet at least partially based on a sequential search for a highest sample within the header portion.

### Example 19

A system of a signal processing chain, comprising: an antenna to receive an incoming communication signal; a signal conditioning unit to process the incoming communication signal to reduce noise and adjust gain; a frequency and phase offset correction unit to align the signal in the time and frequency domains; a matched filter to optimize the signal-to-noise ratio of the processed signal; a timing and synchronization circuit to: determine a down-sampling point in a sequence of samples associated with a header portion of a packet; freeze the determined down-sampling point after the header portion is processed; and maintain the frozen down-sampling point for use throughout the remainder of the packet; a decoder block to decode the symbols associated with the frozen down-sampling point provided by the timing and synchronization circuit; and a depacketization unit to structure the decoded data into usable packets.

### Example 20

The system according to Example 19, wherein the timing and synchronization circuit limits the determination of the down-sampling point to the header portion of the packet.

### Example 21

The system according to any of Examples 19 and 20, further comprising a control signal generator to send a freeze signal to the timing and synchronization circuit to indicate when to maintain the determined down-sampling point for the remainder of the packet.

### Example 22

The system according to any of Examples 19 through 21, wherein the timing and synchronization circuit to perform a sequential search for a highest sample within the header portion of the packet to determine the down-sampling point.

### Example 23

The system according to any of Examples 19 through 22, wherein the signal conditioning unit, the frequency and phase offset correction unit, and the matched filter are to provide up-samples of the packet to the timing and synchronization circuit for determining the down-sampling point.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method, comprising:
obtaining samples associated with one or more symbols of a packet;
determining at least one down-sampling point in a sequence of samples associated with a header portion of the packet; and
utilizing samples associated with the determined down-sampling point to recover the one or more symbol and subsequent symbols.

2. The method of claim 1, wherein the subsequent symbols are recovered without re-determining the down-sampling point or determining a new down-sampling point.

3. The method of claim 1, wherein the obtained samples are up-samples of the packet.

4. The method of claim 1, comprising freezing the determined down-sampling point after the header portion of the packet is processed, and maintaining the frozen down-sampling point for the duration of the packet.

5. The method of claim 1, comprising initializing a current max sample register with a predetermined or random value before determining the down-sampling point.

6. The method of claim 1, wherein determining the down-sampling point comprises sequentially comparing each sample in the header portion to identify the sample with the highest value.

7. The method of claim 1, further comprising resetting or reinitializing the down-sampling point determination process at the start of a new packet.

8. The method of claim 4, further comprising generating a control signal to freeze the down-sampling point after the header portion is processed.

9. The method of claim 1, wherein the determining at least one down-sampling point in the sequence of samples associated with the header portion of the packet comprises determining the at least one down-sampling point at least partially based on a sequential search for a highest sample within the header portion.

10. An apparatus, comprising:
a symbol recovery circuit; and
a timing and synchronization circuit to determine at least one down-sampling point at least partially based on a sequence of samples associated with a header portion of a packet and indicate the determined down-sampling point to the symbol recovery circuit.

11. The apparatus of claim 10, wherein the symbol recovery circuit to recover subsequent symbols without re-determining or determining a new down-sampling point after the initial down-sampling point is determined.

12. The apparatus of claim 10, wherein the timing and synchronization circuit to obtain up-samples of the packet as the sequence of samples associated with the one or more symbols.

13. The apparatus of claim 10, wherein the timing and synchronization circuit to freeze the determined down-sampling point after the header portion of the packet is processed and maintain the frozen down-sampling point for the duration of the packet.

14. The apparatus of claim 10, further comprising a current max sample register to be initialized with a predetermined or random value before the timing and synchronization circuit determines the down-sampling point.

15. The apparatus of claim 10, wherein the timing and synchronization circuit to determine the down-sampling point by sequentially comparing each sample in the header portion to identify the sample with the highest value.

16. The apparatus of claim 10, wherein the timing and synchronization circuit to reset or reinitialize the down-sampling point determination process at the start of a new packet.

17. The apparatus of claim 13, further comprising a control signal generator to generate a control signal to freeze the down-sampling point after the header portion of the packet is processed.

18. The apparatus of claim 10, wherein the timing and synchronization circuit to determine the at least one down-sampling point in the sequence of samples associated with the header portion of the packet at least partially based on a sequential search for a highest sample within the header portion.

19. A system of a signal processing chain, comprising:
an antenna to receive an incoming communication signal;
a signal conditioning unit to process the incoming communication signal to reduce noise and adjust gain;
a frequency and phase offset correction unit to align the signal in the time and frequency domains;
a matched filter to optimize the signal-to-noise ratio of the processed signal;
a timing and synchronization circuit to:
determine a down-sampling point in a sequence of samples associated with a header portion of a packet;
freeze the determined down-sampling point after the header portion is processed; and
maintain the frozen down-sampling point for use throughout the remainder of the packet;
a decoder block to decode the symbols associated with the frozen down-sampling point provided by the timing and synchronization circuit; and
a depacketization unit to structure the decoded data into usable packets.

20. The system of claim 19, wherein the timing and synchronization circuit limits the determination of the down-sampling point to the header portion of the packet.

21. The system of claim 19, further comprising a control signal generator to send a freeze signal to the timing and synchronization circuit to indicate when to maintain the determined down-sampling point for the remainder of the packet.

22. The system of claim 19, wherein the timing and synchronization circuit to perform a sequential search for a highest sample within the header portion of the packet to determine the down-sampling point.

23. The system of claim 19, wherein the signal conditioning unit, the frequency and phase offset correction unit, and the matched filter are to provide up-samples of the packet to the timing and synchronization circuit for determining the down-sampling point.
